(19) United States
(12) Patent Application Publication
(10) Pub. No.: US 2026/0088674 A1
(43) Pub. Date: Mar. 26, 2026

(54) STATOR AND METHOD FOR MANUFACTURING STATOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kanzo ISHIHARA, Osaka (JP)

(21) Appl. No.: 19/109,566

(22) PCT Filed: Aug. 24, 2023
(86) PCT No.: PCT/JP2023/030407

§ 371 Date: Mar. 7, 2025

(30) Foreign Application Priority Data
Sep. 14, 2022 (JP) 2022-146432

(51) Int. Cl. H02K 3/28; H02K 1/16; H02K 3/34; H02K 15/026; H02K 15/122; H02K 15/33

(52) U.S. Cl. CPC H02K 3/28; H02K 1/16; H02K 3/345; H02K 15/026; H02K 15/122; H02K 15/33; H02K 2203/09

(57) ABSTRACT

A stator (1) includes a stator core (10), a coil (20), a conducting portion (60), and an insulating resin (40). The stator core (10) has an annular shape. The coil (20) includes a protruding portion (29) that protrudes to one axial side more than an end portion at the one axial side of the stator core (10). A conducting portion (60) is connected to the protruding portion (29). The insulating resin (40) includes a press-fit groove (50) between the insulating resin (40) and the protruding portion (29). The conducting portion (60) is disposed in a state in which the conducting portion (60) is press-fitted into the press-fit groove (50) and pressed against the protruding portion (29).

### TECHNICAL FIELD

The present disclosure relates to a stator and a method for manufacturing the stator.

### BACKGROUND

Patent Document 1 discloses a stator portion of a molded motor. The stator portion includes a winding. A terminal pin is soldered to a winding end portion of the winding. The terminal pin is connected to a target device (for example, a component for driving the motor) through a connector. The terminal pin is soldered in Patent Document 1, but the terminal pin is also generally welded instead of soldered.

### PRIOR ART DOCUMENT

### Patent Document

Patent Document 1: JP 2013-215025 A

### SUMMARY OF THE INVENTION

### Problems to be Solved

A technology is desired that allows a connection state between a coil and a conducting portion (terminal pin) to be easily maintained without providing the welded portion or the soldered portion described above.

An object of the present disclosure is to provide a technology that allows the connection state between the coil and the conducting portion to be easily maintained without providing the welded portion or the soldered portion.

### Means to Solve the Problem

A stator of the present disclosure includes: an annular stator core; a coil including a protruding portion that protrudes to one axial side more than an end portion at the one axial side of the stator core; a conducting portion connected to the protruding portion; and an insulating resin including a press-fit groove between the insulating resin and the protruding portion, wherein the conducting portion is disposed in a state in which the conducting portion is press-fitted into the press-fit groove and pressed against the protruding portion.

A method for manufacturing a stator of the present disclosure includes: a preparation step of preparing a stator body including an annular stator core, a coil including a protruding portion that protrudes to one axial side more than an end portion at the one axial side of the stator core, a conducting portion connected to the protruding portion, and an insulating resin including a press-fit groove between the insulating resin and the protruding portion; and a press-fitting step of press-fitting the conducting portion into the press-fit groove of the stator body and pressing the conducting portion against the protruding portion.

### Effect of the Invention

A technology according to the present disclosure allows a connection state between a coil and a conducting portion to be easily maintained without providing a welded portion or a soldered portion.

### BRIEF DESCRIPTION OF THE DRAWINGS

FIG. 1 is a perspective view of a stator of a first embodiment.

FIG. 2 is a plan view of the stator of the first embodiment.

FIG. 3 is a perspective view of a state in which a coil is attached to a stator core.

FIG. 4 is a perspective view of a stator body.

FIG. 5 is a perspective view of the stator body cut in an axial direction.

FIG. 6 is an explanatory diagram illustrating a state before a unit component is attached to the stator body.

FIG. 7 is an explanatory diagram for describing how a conducting portion is press-fitted into a press-fit groove in a cross-section along a line A-A of FIG. 2.

FIG. 8 is an explanatory diagram for describing how a conducting portion of a second embodiment is press-fitted into the press-fit groove.

FIG. 9 is a plan view around the press-fit groove of the second embodiment.

FIG. 10 is an explanatory diagram for describing how a conducting portion of a third embodiment is press-fitted into the press-fit groove.

FIG. 11 is a plan view around the press-fit groove of the third embodiment.

FIG. 12 is an explanatory diagram for describing how a conducting portion of a fourth embodiment is press-fitted into the press-fit groove.

FIG. 13 is a plan view around the press-fit groove of the fourth embodiment.

FIG. 14 is a plan view of a stator body of a fifth embodiment.

FIG. 15 is a plan view of the stator of the fifth embodiment.

### DESCRIPTION OF EMBODIMENTS

Hereinafter, embodiments of the present disclosure will be listed as examples.

(1) A stator including: an annular stator core; a coil including a protruding portion that protrudes to one axial side more than an end portion at the one axial side of the stator core; a conducting portion connected to the protruding portion; and an insulating resin including a press-fit groove between the insulating resin and the protruding portion, wherein the conducting portion is disposed in a state in which the conducting portion is press-fitted into the press-fit groove and pressed against the protruding portion.

The above stator allows a connection state between the coil and the conducting portion to be easily maintained without providing a welded portion or a soldered portion, since the conducting portion is disposed in the state in which the conducting portion is press-fitted into the press-fit groove and pressed against the protruding portion.

(2) The stator according to (1), wherein a plurality of the protruding portions are provided, the plurality of protruding portions are regularly arranged in a circumferential direction of the stator core, the insulating resin includes a plurality of the press-fit grooves regularly arranged in the circumferential direction, the plurality of press-fit grooves being disposed between the insulating resin and the plurality of protruding portions regularly arranged in the circumferential direction, a plurality of the conducting portions are provided, the stator further includes a holding portion that holds the plurality of conducting portions, and the conducting portions held by the holding portion are disposed in a state in which the respective conducting portions are press-fitted into the respective press-fit grooves and pressed against the respective protruding portions.

The above stator allows a relative positional relationship between the plurality of conducting portions to be easily maintained, since the plurality of conducting portions connected to the individual protruding portions are held by the holding portion.

(3) The stator according to (2), wherein the plurality of press-fit grooves regularly arranged in the circumferential direction radially extend along a radial direction of the stator core, each of the press-fit grooves includes an opening portion that opens toward the one axial side, and each of the conducting portions is removable from each of the press-fit grooves through the opening portion.

In a configuration in which the plurality of press-fit grooves radially extend, each of the conducting portions causes friction with an inner wall of the press-fit grooves upon removing the conducting portions press-fitted into the press-fit grooves collectively in a radially outward manner. However, since the conducting portions are removable from the one axial side through the opening portions, the conducting portions are unlikely to cause friction with the press-fit grooves. As a result, the above stator allows the plurality of conducting portions integrally formed via the holding portion to be easily collectively removed.

(4) The stator according to (2) or (3), wherein each of the press-fit grooves includes an outer circumferential opening portion that opens radially outward of the stator core, the holding portion is disposed at a more radially outward position than the plurality of press-fit grooves regularly arranged in the circumferential direction, and the respective conducting portions held by the holding portion protrude from a surface at an inner radial side of the holding portion and are disposed in the respective press-fit grooves via the outer circumferential opening portions.

This allows the size of the above stator in the axial direction to be easily reduced, since the holding portion that holds the plurality of conducting portions is disposed at the more radially outward position than the plurality of the press-fit grooves regularly arranged in the circumferential direction.

(5) The stator according to any one of (2) to (4), the stator is a stator used in a motor, the stator including: a terminal portion electrically connected to a drive unit that drives the motor, wherein the terminal portion has a form in which the terminal portion protrudes from a surface at an outer radial side of the holding portion.

This allows the size of the above stator in the axial direction to be easily reduced, since the terminal portion has a form in which the terminal portion protrudes from the surface at the outer radial side of the holding portion.

(6) The stator according to any one of (3) to (5), wherein each of the press-fit grooves includes an outer circumferential opening portion that opens radially outward of the stator core, the holding portion is disposed at a more radially outward position than the plurality of press-fit grooves regularly arranged in the circumferential direction, the respective conducting portions press-fitted into the respective press-fit grooves are coupled to a surface at the inner radial side of the holding portion via the outer circumferential opening portions, and the opening portion and the outer circumferential opening portion open continuously.

This allows the size of the above stator in the axial direction to be easily reduced, since the holding portion that holds the plurality of conducting portions is disposed at the more radially outward position than the plurality of the press-fit grooves regularly arranged in the circumferential direction. In other words, the above stator allows the plurality of conducting portions integrally formed via the holding portion to be collectively removable from the one axial side, which allows the size of the stator in the axial direction to be easily reduced.

(7) The stator according to any one of (2) to (6), wherein the holding portion has a form in which the holding portion extends along the circumferential direction in a circular arc shape, and each of the plurality of conducting portions is disposed at a side at which a circumferential direction center of the holding portion is located with respect to a corresponding one of the plurality of protruding portions being a connection target.

The above stator allows a connection state between the conducting portions and the protruding portions to be easily maintained, since each of the conducting portions is displaced to a side at which the corresponding one of the protruding portions being the connection target is disposed, even when the holding portion thermally expands and deforms so that a curvature thereof is reduced.

(8) The stator according to any one of (1) to (7), wherein a plurality of the protruding portions are provided, the plurality of protruding portions are regularly arranged in a circumferential direction of the stator core, the insulating resin includes a plurality of the press-fit grooves regularly arranged in the circumferential direction, the plurality of press-fit grooves being disposed between the insulating resin and the plurality of protruding portions regularly arranged in the circumferential direction, a plurality of the conducting portions are provided, the conducting portions are disposed in a state in which the respective conducting portions are press-fitted into the respective press-fit grooves and pressed against the respective protruding portions, an entirety in the axial direction of each conducting portion is fitted inside a corresponding press-fit groove, and a side of the protruding portions opposite to a press-fit groove side is covered by the insulating resin.

The above stator allows the space between the protruding portions and the conducting portions to be easily insulated, the conducting portions being connected to the protruding portions and adjacent ones of the protruding portions in the circumferential direction. This is because the entirety in the axial direction of each conducting portion is fitted inside the corresponding press-fit groove and the side of the protruding portions opposite to the press-fit groove side is covered by the insulating resin.

(9) The stator according to any one of (1) to (8), wherein the stator core includes a plurality of slots regularly arranged in a circumferential direction of the stator core, the coil includes an insertion portion disposed in each slot, the insulating resin includes a filling portion that is filled continuously between an inner wall of each slot and the insertion portion, and a forming portion in which the press-fit groove is formed, and the filling portion and the forming portion are integrally formed.

The above stator allows heat in the coil to escape easily, since the heat produced in the insertion portion of the coil and the conducting portion is easily transferred to the stator core via the insulating resin.

(10) The stator according to any one of (1) to (9), wherein the coil includes two or more protruding portions regularly arranged in a radial direction of the stator core, one of the press-fit grooves is formed between the two or more protruding portions and the insulating resin, and one of the conducting portions is disposed in the state in which the one conducting portion is press-fitted into the one press-fit groove and pressed against the two or more protruding portions forming the press-fit groove.

The above stator allows the one conducting portion to be connected to the two or more protruding portions regularly arranged in the radial direction.

(11) A method for manufacturing a stator, the method including: a preparation step of preparing a stator body including an annular stator core, a coil including a protruding portion that protrudes to one axial side more than an end portion at the one axial side of the stator core, a conducting portion connected to the protruding portion, and an insulating resin including a press-fit groove between the insulating resin and the protruding portion; and a press-fitting step of press-fitting the conducting portion into the press-fit groove of the stator body and pressing the conducting portion against the protruding portion.

The above method of manufacturing the stator allows a connection state between the conducting portion and the protruding portion to be easily maintained without providing a welded portion or a soldered portion, since the conducting portion is pressed against the protruding portion by press-fitting the conducting portion into the press-fit groove.

(12) The method for manufacturing the stator according to (11), wherein the preparation step includes preparing a unit component having a configuration in which a plurality of the conducting portions are held by a holding portion, a plurality of the protruding portions are provided, the plurality of protruding portions are regularly arranged in a circumferential direction of the stator core, the insulating resin includes a plurality of the press-fit grooves regularly arranged in the circumferential direction, the plurality of press-fit grooves being disposed between the insulating resin and the plurality of protruding portions regularly arranged in the circumferential direction, each of the press-fit grooves includes an opening portion that opens toward the one axial side, and the press-fitting step includes press-fitting the respective conducting portions into the respective press-fit grooves via the opening portions, by displacing the unit component to an other axial side.

According to the above method of manufacturing the stator, the plurality of conducting portions can be collectively pressed into the press-fit grooves and pressed against the protruding portions forming the press-fit grooves.

(13) The method for manufacturing the stator according to (11) or (12), wherein the stator core includes a plurality of slots regularly arranged in a circumferential direction of the stator core, the coil includes an insertion portion disposed in each slot, the method further includes a filling step of charging a resin material between an inner wall of each slot and the insertion portion, and the filling step forms the press-fit groove while charging the resin material between the inner wall of the slot and the insertion portion.

The above method for manufacturing the stator allows a manufacturing step to be easily simplified, since the press-fit groove can be formed when charging the resin material between the inner wall of the slot and the insertion portion.

### First Embodiment

### 1. Configuration of Stator 1

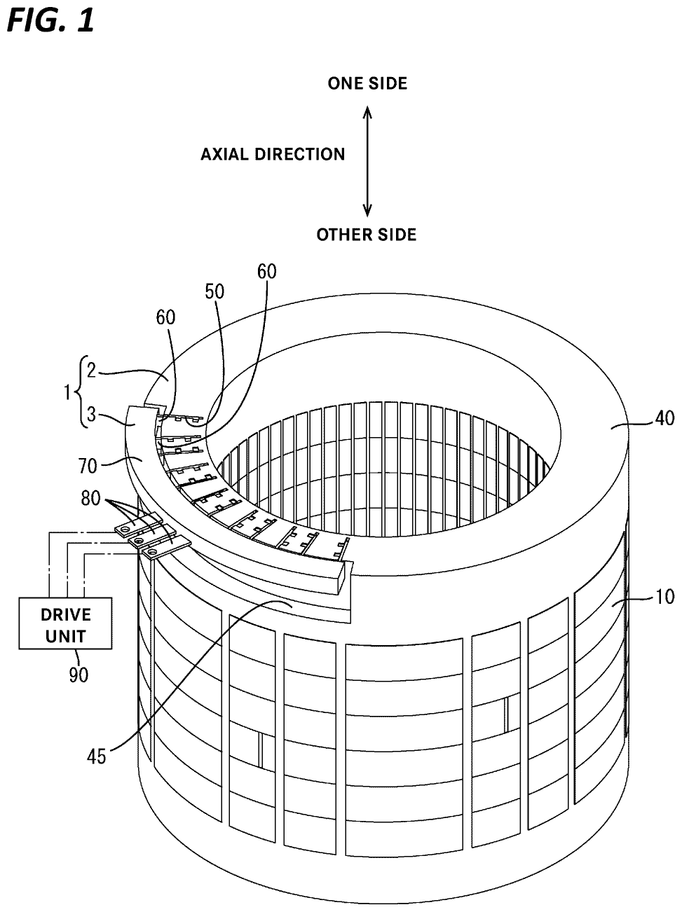

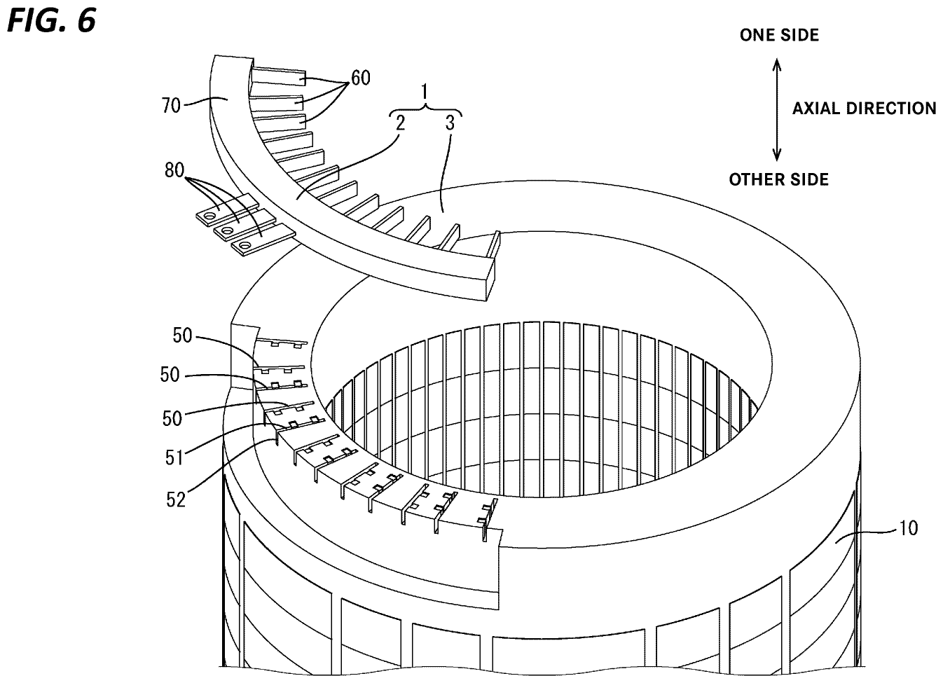

A stator 1 of a first embodiment is used as a component of a motor. The stator 1 has an annular shape and more specifically a toric shape. As illustrated in FIGS. 1 and 6, the stator 1 has a configuration in which a unit component 3 is coupled to a stator body 2.

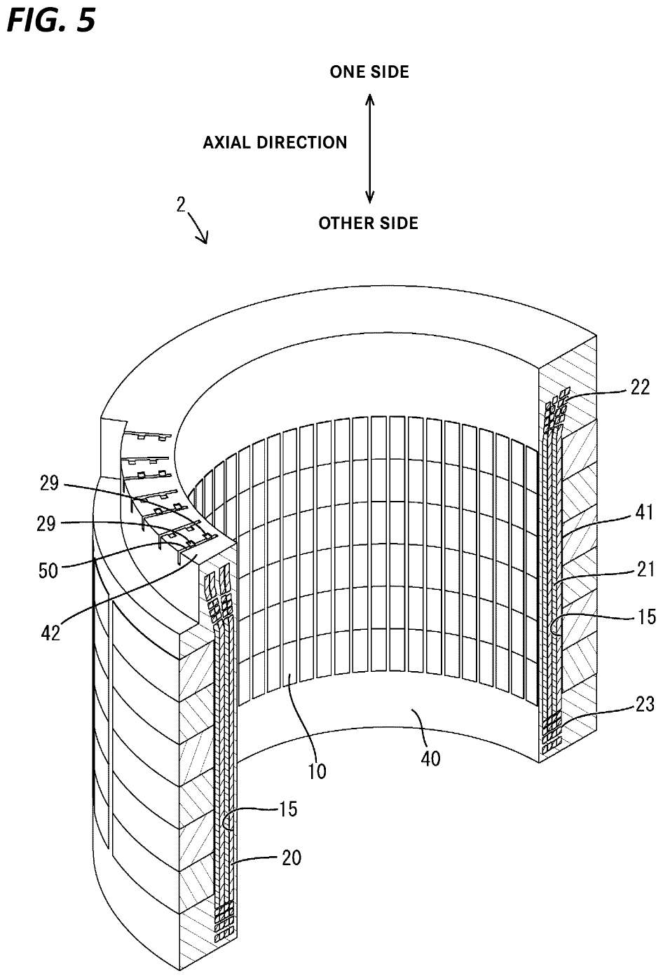

As illustrated in FIG. 5, the stator body 2 includes a stator core 10, a coil 20, and an insulating resin 40.

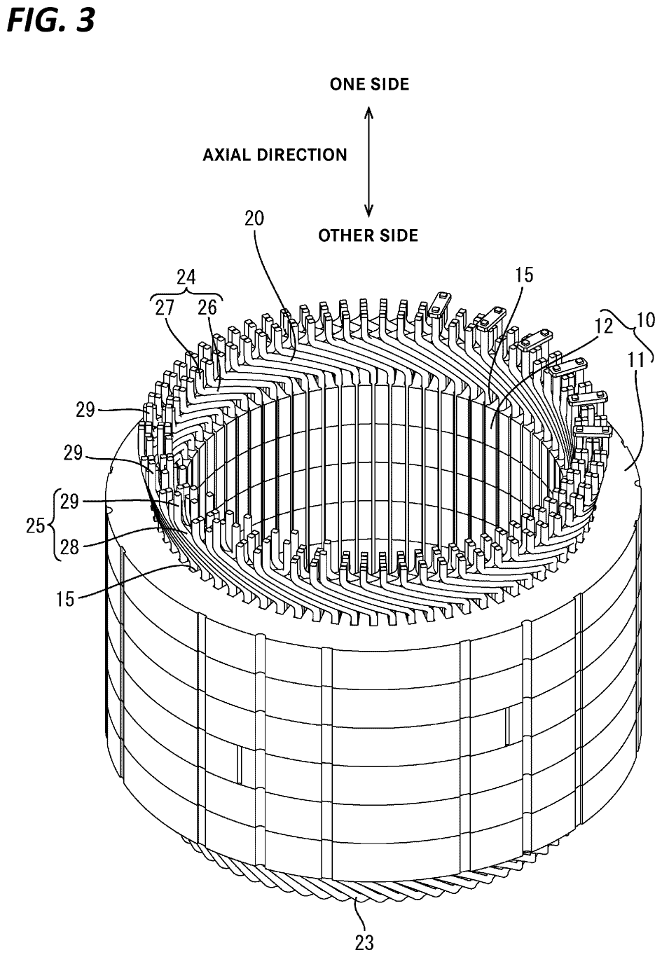

As illustrated in FIG. 3, the stator core 10 has an annular shape and more specifically a toric shape. Hereinafter, a radial direction of the stator core 10 is referred to as the radial direction, an axial direction of the stator core 10 is referred to as the axial direction, and a circumferential direction of the stator core 10 is referred to as the circumferential direction.

The stator core 10 may be, for example, a laminated steel plate manufactured by stacking a plurality of magnetic steel sheets (for example, silicon steel sheets) in the axial direction (thickness direction) or a powder magnetic core formed by press molding insulation-coated magnetic particles.

As illustrated in FIG. 3, the stator core 10 includes a yoke portion 11 and a plurality of teeth portions 12. The yoke portion 11 has an annular shape and more specifically a toric shape. The plurality of teeth portions 12 are annularly and regularly arranged along an inner circumferential surface of the yoke portion 11. The teeth portions 12 are disposed with a space therebetween in the circumferential direction. Each teeth portion 12 protrudes radially inward from an inner circumferential portion of the yoke portion 11. Each teeth portion 12 is wall-shaped along the radial direction and the axial direction. Each teeth portion 12 has a form in which an end portion at an inner radial side of the teeth portion 12 projects at both circumferential sides.

As illustrated in FIG. 3, the stator core 10 includes a plurality of slots 15. The plurality of slots 15 are regularly arranged in the circumferential direction and have an annular shape. The slots 15 extend through the stator core 10 in the axial direction. As illustrated in FIG. 3, each slot 15 is formed by the yoke portion 11 and two adjacent teeth portions 12 being partitioned. The slots 15 open in a surface of the stator core 10 at both axial sides and opens in a surface of the stator core 10 at the inner radial side.

As illustrated in FIG. 3, the coil 20 is attached to the stator core 10. The coil 20 is wound on the stator core 10 (more specifically, the teeth portions 12). The coil 20 may be a distributed winding or a concentrated winding. When the coil 20 is a distributed winding, the coil 20 may be a wave winding, a coaxial winding, or a lap winding. In the present embodiment, the coil 20 is described as a wave winding. The coil 20 passes through the slots 15 and is wound on the teeth portions 12. The coil 20 may be coated wire or an uncoated wire, the coated wire having a core wire whose circumference is covered with a coating. In the present embodiment, the coil 20 is a rectangular wire. Note that the coil 20 need not be a rectangular wire and may be, for example, a round wire.

As illustrated in FIG. 5, the coil 20 includes an insertion portion 21, a one-side coil end 22, and an other-side coil end 23.

As illustrated in FIG. 5, the insertion portion 21 is disposed in the slot 15. The insertion portion 21 has a longitudinal shape that is elongated in the axial direction. A plurality of the insertion portions 21 are provided inside the slot 15 (four in the present embodiment). The insertion portions 21 are regularly arranged in the radial direction in the slot 15. The insertion portions 21 are disposed in each slot 15.

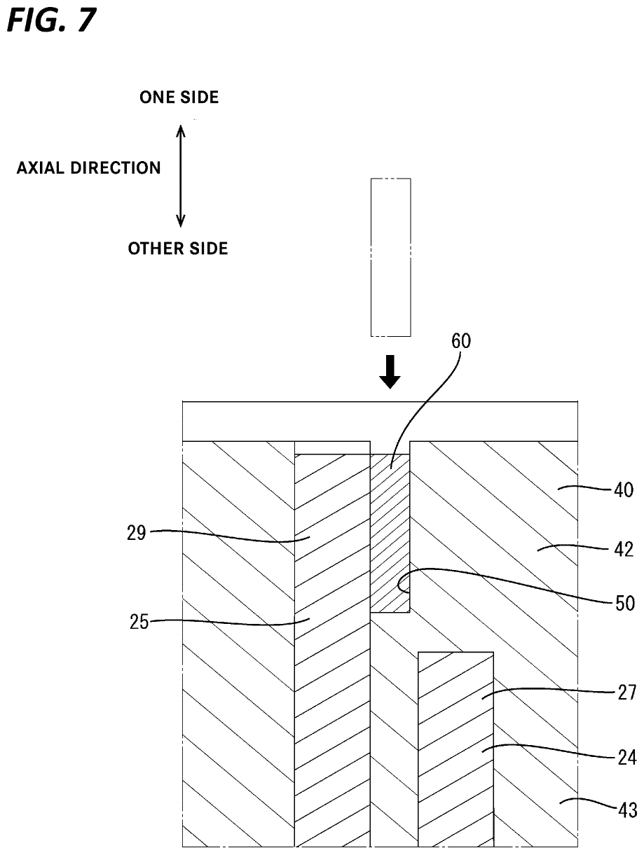

As illustrated in FIGS. 3 and 5, the one-side coil end 22 is disposed closer to one axial side than an end portion at the one axial side of the stator core 10 is. The one-side coil end 22 is continuous with an end portion at the one axial side of the insertion portion 21. As illustrated in FIGS. 3 and 7, the one-side coil end 22 includes a first coil end 24 to which a conducting portion 60 (see FIG. 6) does not connect and a second coil end 25 to which the conducting portion 60 connects.

As illustrated in FIG. 3, the first coil end 24 includes a first lead portion 26 and an extending portion 27. The first lead portion 26 is continuous with the end portion at the one axial side of the insertion portion 21. The first lead portion 26 has a form in which the first lead portion 26 is inclined in the circumferential direction. The extending portion 27 extends from an end portion at the one axial side of the first lead portion 26 (the end portion at a side opposite to a side at which the insertion portion 21 of the first lead portion 26 is disposed) toward the one axial side. The extending portion 27 has a form in which the extending portion 27 extends along the axial direction. The extending portion 27 is connected to another extending portion 27. A connection method thereof is not particularly limited, and the extending portions 27 may be welded or soldered.

As illustrated in FIG. 3, the second coil end 25 includes a second lead portion 28 and a protruding portion 29. The second lead portion 28 is continuous with the end portion at the one axial side of the insertion portion 21. The second lead portion 28 has a form in which the second lead portion 28 is inclined to one side in the circumferential direction. The protruding portion 29 extends from an end portion at the one axial side of the second lead portion 28 (the end portion at a side opposite to a side at which the insertion portion 21 of the second lead portion 28 is disposed) toward the one axial side. The protruding portion 29 has a form in which the protruding portion 29 protrudes along the axial direction. The protruding portion 29 is longer than the extending portion 27. A distal end portion (end portion at the one axial side) of the protruding portion 29 is disposed closer to the one axial side than a distal end portion (end portion at the one axial side) of the extending portion 27 is. The distal end portion (end portion at the one axial side) of the protruding portion 29 is disposed closer to the one axial side than a distal end portion (end portion at the one axial side) of the first coil end 24 is. A plurality of the protruding portions 29 are provided. The plurality of protruding portions 29 are regularly arranged in the circumferential direction.

As illustrated in FIGS. 3 and 5, the other-side coil end 23 is disposed closer to the other axial side than an end portion at the other axial side of the stator core 10 is. The other-side coil end 23 is continuous with an end portion at the other axial side of the insertion portion 21.

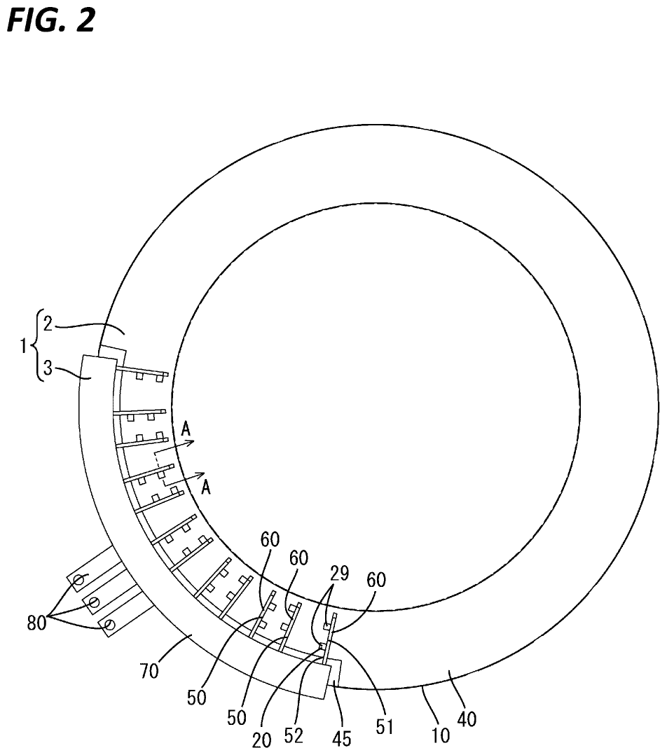

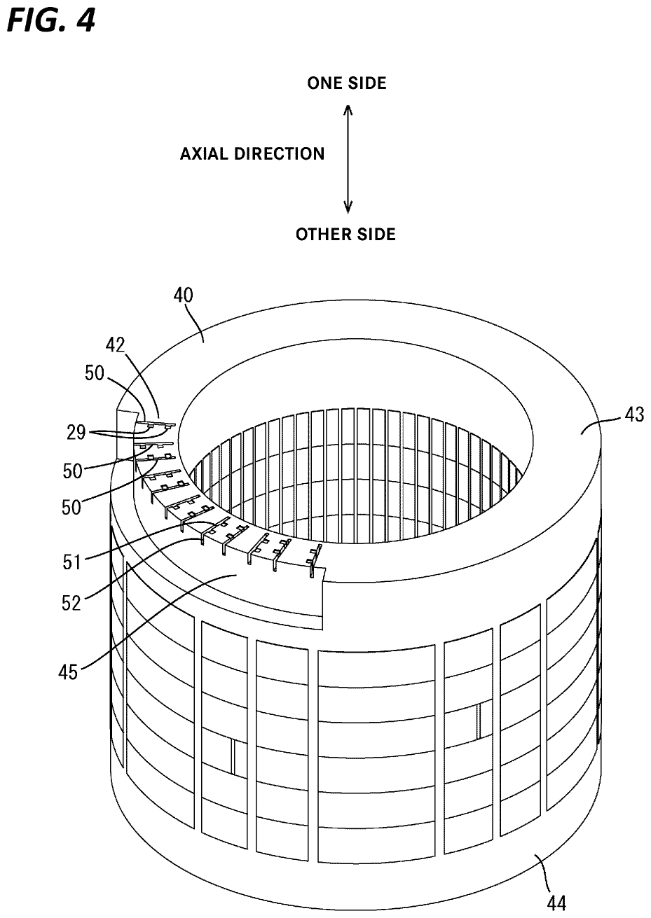

As illustrated in FIGS. 2 and 4, the insulating resin 40 includes a press-fit groove 50 between the insulating resin 40 and the protruding portions 29. The press-fit groove 50 has a form in which the press-fit groove 50 extends along the radial direction. A width of the press-fit groove 50 is orthogonal to a direction in which the press-fit groove 50 extends and orthogonal to the axial direction. The press-fit groove 50 includes an opening portion 51 that opens toward the one axial side. The opening portion 51 opens in a surface at the one axial side of the stator body 2. The press-fit groove 50 includes an outer circumferential opening portion 52 that opens radially outward. The outer circumferential opening portion 52 opens in a surface at an outer radial side of the stator body 2. The opening portion 51 and the outer circumferential opening portion 52 open continuously. The insulating resin 40 includes a plurality of the press-fit grooves 50 regularly arranged in the circumferential direction, the plurality of press-fit grooves 50 being disposed between the insulating resin 40 and the plurality of protruding portions 29 regularly arranged in the circumferential direction.

As illustrated in FIG. 5, the insulating resin 40 includes a filling portion 41 and a forming portion 42. The filling portion 41 is filled continuously between an inner wall of the slots 15 and the insertion portion 21. The forming portion 42 includes the protruding portion 29 and the press-fit groove 50. The filling portion 41 and the forming portion 42 are integrally formed. According to this configuration, the stator 1 allows heat in the coil 20 to escape easily, since the heat produced in the insertion portion 21 of the coil 20 and the conducting portion 60 is easily transferred to the stator core 10 via the insulating resin 40.

As illustrated in FIG. 4, the insulating resin 40 includes a one-side resin 43 provided closer to the one axial side than the stator core 10 is and an other-side resin 44 provided closer to the other axial side than the stator core 10 is.

As illustrated in FIGS. 4 and 5, the one-side resin 43 covers an entirety of the first coil end 24 and the second lead portion 28 of the second coil end 25. In other words, the one-side resin 43 covers the one-side coil end 22 excluding the protruding portion 29. The one-side resin 43 includes the forming portion 42. The one-side resin 43 includes a recessed portion 45 that is recessed radially inward more than an end portion at the outer radial side of the stator core 10. The outer circumferential opening portion 52 described above opens in a surface on the deep side of the recessed portion 45. The one-side resin 43 is continuous with the filling portion 41. The recessed portion 45 opens in a surface at the one axial side of the insulating resin 40.

As illustrated in FIG. 5, the other-side resin 44 covers an entirety of the other-side coil end 23. The other-side resin 44 is continuous with the filling portion 41.

As illustrated in FIGS. 1 and 6, the unit component 3 includes the conducting portion 60, a holding portion 70, and a terminal portion 80. The unit component 3 has a configuration in which a plurality of the conducting portions 60 are held by the holding portion 70.

The conducting portion 60 is, for example, a busbar. As illustrated in FIG. 6, the conducting portion 60 is plate-shaped. A plate thickness direction of the conducting portion 60 is a direction along the circumferential direction. A plate thickness of the conducting portion 60 is slightly larger than the width of the press-fit groove 50 (space between the protruding portion 29 and the forming portion 42 of the insulating resin 40) in a state before press-fitting. Accordingly, the conducting portion 60 is disposed in the press-fit groove 50 in a press-fitted state. The conducting portion 60 extends along the radial direction.

As illustrated in FIG. 7, the conducting portion 60 is disposed in a state in which the conducting portion 60 is press-fitted into the press-fit groove 50 and pressed against the protruding portion 29. With this, the conducting portion 60 is connected to the protruding portion 29 forming the press-fit groove 50. In this manner, the stator 1 allows a connection state between the coil 20 and the conducting portion 60 to be easily maintained without providing a welded portion or a soldered portion, since the conducting portion 60 is disposed in the state in which the conducting portion 60 is press-fitted into the press-fit groove 50 and pressed against the protruding portion 29.

As illustrated in FIGS. 2 and 6, a plurality of the conducting portions 60 are provided. The plurality of conducting portions 60 are regularly arranged in the circumferential direction. The plurality of conducting portions 60 are radially disposed.

As illustrated in FIGS. 2 and 6, the holding portion 70 has a form in which the holding portion 70 extends along the circumferential direction in a circular arc shape. An inner circumferential surface of the holding portion 70 has a form in which the inner circumferential surface extends along the circumferential direction in a circular arc shape. An outer circumferential surface of the holding portion 70 has a form in which the outer circumferential surface extends along the circumferential direction in a circular arc shape. The holding portion 70 holds the plurality of conducting portions 60. The conducting portions 60 held by the holding portion 70 are disposed in the state in which the respective conducting portions 60 are press-fitted into the respective press-fit grooves 50 and pressed against the respective protruding portions 29. In this manner, the stator 1 allows a relative positional relationship between the plurality of conducting portions 60 to be easily maintained, since the plurality of conducting portions 60 connected to the individual protruding portions 29 are held by the holding portion 70.

As illustrated in FIGS. 1 and 2, the holding portion 70 is disposed in a state in which the holding portion 70 is fitted into the recessed portion 45 of the insulating resin 40. The holding portion 70 is disposed with a space between the holding portion 70 and the insulating resin 40. The holding portion 70 projects more radially outward than the insulating resin 40. The holding portion 70 projects more at the one axial side than the insulating resin 40. An end portion at the other axial side of the holding portion 70 is disposed closer to the other axial side than an end portion at the one axial side of the press-fit groove 50 is.

As illustrated in FIG. 1, the terminal portion 80 is electrically connected to a drive unit 90 that drives the motor (not illustrated). The motor is a motor used by the stator 1. The motor is, for example, a three-phase motor. Three of the terminal portions 80 are provided. A three-phase alternating current is applied to the three terminal portions 80. The terminal portion 80 is connected to the conducting portion 60 via a relay portion (not illustrated). The relay portion is, for example, embedded in the holding portion 70. The terminal portion 80 has a form in which the terminal portion 80 protrudes radially outward from a surface at the outer radial side of the holding portion 70. This allows the size of the stator 1 in the axial direction to be easily reduced, since the stator 1 has a form in which the terminal portion 80 protrudes from the surface at the outer radial side of the holding portion 70. An end portion at the one axial side of the terminal portion 80 is disposed closer to the other axial side than an end portion at the one axial side of the holding portion 70 is.

As illustrated in FIG. 6, the plurality of press-fit grooves 50 regularly arranged in the circumferential direction radially extend along the radial direction. Each press-fit groove 50 includes the opening portion 51 that opens toward the one axial side. Each conducting portion 60 is removable from the press-fit groove 50 through the opening portion 51. In a configuration in which the plurality of press-fit grooves 50 radially extend, each conducting portion 60 causes friction with an inner wall of the press-fit grooves 50 upon removing the conducting portions 60 press-fitted into the press-fit grooves 50 collectively in a radially outward manner. However, since the conducting portions 60 are removable from the one axial side through the opening portions 51, the conducting portions 60 are unlikely to cause friction with the press-fit grooves 50. As a result, the stator 1 allows the plurality of conducting portions 60 integrally formed via the holding portion 70 to be easily collectively removed.

As illustrated in FIGS. 2 and 6, each press-fit groove 50 includes the outer circumferential opening portion 52 that opens radially outward. The holding portion 70 is disposed at a more radially outward position of the stator core 10 than the plurality of press-fit grooves 50 regularly arranged in the circumferential direction. Each conducting portion 60 held by the holding portion 70 protrudes from a surface at the inner radial side of the holding portion 70 and is disposed in the press-fit groove 50 via the outer circumferential opening portion 52. This allows the size of the stator 1 in the axial direction to be easily reduced, since the holding portion 70 that holds the plurality of conducting portions 60 is disposed at the more radially outward position than the plurality of the press-fit grooves 50 regularly arranged in the circumferential direction.

As illustrated in FIGS. 2 and 6, each press-fit groove 50 includes the outer circumferential opening portion 52 that opens radially outward. The holding portion 70 is disposed at the more radially outward position of the stator core 10 than the plurality of press-fit grooves 50 regularly arranged in the circumferential direction. The respective conducting portions 60 press-fitted into the respective press-fit grooves 50 are coupled to the surface at the inner radial side of the holding portion 70 via the outer circumferential opening portions 52. The opening portion 51 and the outer circumferential opening portion 52 open continuously. This allows the size of the stator 1 in the axial direction to be easily reduced, since the holding portion 70 that holds the plurality of conducting portions 60 is disposed at the more radially outward position than the plurality of the press-fit grooves 50 regularly arranged in the circumferential direction. In other words, the stator 1 allows the plurality of conducting portions 60 integrally formed via the holding portion 70 to be collectively removable from the one axial side, which allows the size of the stator 1 in the axial direction to be easily reduced.

As illustrated in FIGS. 1 and 7, a plurality of the protruding portions 29 are provided. The plurality of protruding portions 29 are regularly arranged in the circumferential direction of the stator core. The insulating resin 40 includes the plurality of the press-fit grooves 50 regularly arranged in the circumferential direction, the plurality of press-fit grooves 50 being disposed between the insulating resin 40 and the plurality of protruding portions 29 regularly arranged in the circumferential direction. A plurality of the conducting portions 60 are provided. The conducting portions 60 are disposed in the state in which the respective conducting portions 60 are press-fitted into the respective press-fit grooves 50 and pressed against the respective protruding portions 29. The entirety in the axial direction of each conducting portion 60 is fitted inside the corresponding press-fit groove 50. A side of the protruding portions 29 opposite to the press-fit groove 50 side is covered by the insulating resin 40. In this manner, the stator 1 allows the space between the protruding portions 29 and the conducting portions 60 to be easily insulated, the conducting portions 60 being connected to the protruding portions 29 and adjacent ones of the protruding portions 29 in the circumferential direction. This is because the entirety in the axial direction of each conducting portion 60 is fitted inside the corresponding press-fit groove 50 and the side of the protruding portions 29 opposite to the press-fit groove 50 side is covered by the insulating resin 40.

As illustrated in FIG. 2, the coil 20 includes two or more protruding portions 29 regularly arranged in the radial direction of the stator core 10. One press-fit groove 50 is formed between the two or more protruding portions 29 regularly arranged in the radial direction and the insulating resin 40. One conducting portion 60 is disposed in the state in which the one conducting portion 60 is press-fitted into the one press-fit groove 50 and pressed against the two or more protruding portion 29 forming the press-fit groove 50. According to this configuration, the stator 1 allows the one conducting portion 60 to be connected to the two or more protruding portions 29 regularly arranged in the radial direction.

### 2. Method for Manufacturing Stator 1

A method for manufacturing the stator 1 includes a filling step, a preparation step, and a press-fitting step.

The filling step is a step in which a resin material is charged in the slot 15 of the stator core 10 to which the coil 20 is attached. In the filling step, the stator body 2 is insert molded with the stator core 10 to which the coil 20 is attached as insert component. In the filling step, the press-fit groove 50 is formed while charging the resin material between the inner wall of the slot 15 and the insertion portion 21. This method allows a manufacturing step to be easily simplified, since the press-fit groove 50 can be formed when charging the resin material between the inner wall of the slot 15 and the insertion portion 21.

In the preparation step, the stator body 2 and the unit component 3 are prepared.

In the press-fitting step, the conducting portion 60 is press-fitted into the press-fit groove 50 of the stator body 2 and the conducting portion 60 is pressed against the protruding portion 29. This method allows a connection state between the conducting portion 60 and the protruding portion 29 to be easily maintained without providing a welded portion or a soldered portion, since the conducting portion 60 is pressed against the protruding portion 29 by press-fitting the conducting portion 60 into the press-fit groove 50.

In the press-fitting step, the respective conducting portions 60 are press-fitted into the respective press-fit grooves 50 via the opening portion 51, by displacing the unit component 3 to the other axial side. According to this method, the plurality of conducting portions 60 can be collectively press-fitted into the press-fit grooves 50 and pressed against the protruding portions 29 forming the press-fit grooves 50.

### Second Embodiment

The conducting portion is not limited to the configuration of the first embodiment. In a second embodiment, another example of the conducting portion will be described. Note that in the description of the second embodiment, constituent elements identical to those in the first embodiment will be denoted by the same reference numerals and detailed description thereof will be omitted.

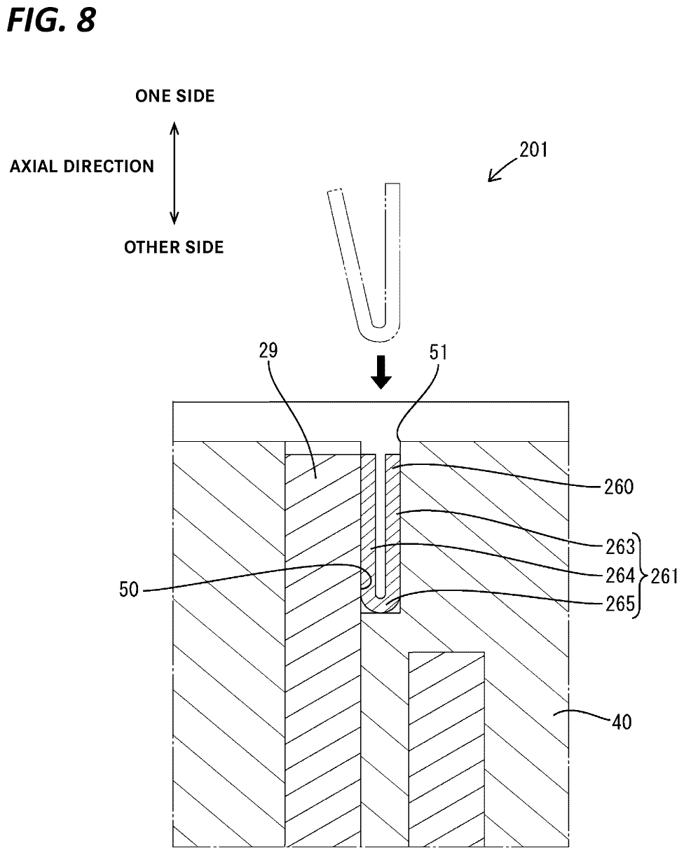

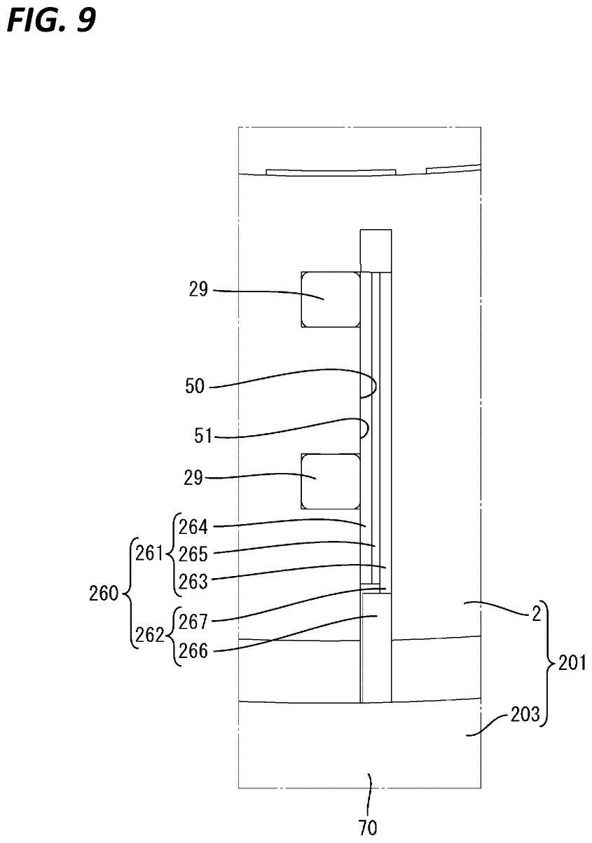

As illustrated in FIGS. 8 and 9, a stator 201 of the second embodiment includes the stator body 2 and a unit component 203. The unit component 203 includes a conducting portion 260, the holding portion 70, and the terminal portion 80 (see FIG. 1).

The conducting portion 260 includes a spring portion 261 and a supporting portion 262. The spring portion 261 warps so as to shrink in the circumferential direction. The spring portion 261 has a form in which the spring portion 261 is plate spring-shaped and is formed by bending a metal plate. The spring portion 261 includes a pair of plate portions 263 and 264, and a bent portion 265 that joins one ends of the plate portion 263, 264. The pair of plate portions 263 and 264 extend from the bent portion 265 to the one axial side. In a state in which the spring portion 261 is not warped, a space between the pair of plate portions 263 and 264 widens with increasing distance from the bent portion 265. The spring portion 261 warps so that the other end of the plate portion 263 and the other end of the plate portion 264 approach each other with the bent portion 265 as supporting point. The spring portion 261 is disposed in the press-fit groove 50 in a warped state. The entirety in the axial direction of the spring portion 261 is disposed in the press-fit groove 50. The warped spring portion 261 exerts an elastic force so as to widen in a width direction of the press-fit groove 50. In other words, the spring portion 261 is in a press-fitted state in the press-fit groove 50. Accordingly, the spring portion 261 is disposed in a state in which the spring portion 261 is pressed against the protruding portion 29. The spring portion 261 is disposed in the state in which the spring portion 261 is pressed against two or more (two in the present embodiment) protruding portions 29 regularly arranged in the radial direction.

The pair of plate portions 263 and 264 face each other in the circumferential direction. The plate portion 264 is disposed closer to the protruding portion 29 side than the plate portion 263 is. In other words, the plate portion 264 is disposed in a state in which the plate portion 264 is pressed against the protruding portion 29. The plate portion 264 is disposed in the state in which the plate portion 264 is pressed against the two or more (two in the present embodiment) protruding portions 29 regularly arranged in the radial direction. According to this configuration, the stator 201 allows a connection state between the conducting portion 260 and the protruding portion 29 to be stabilized more easily, since the spring portion 261 is pressed against the protruding portion 29 due to the elastic force of the spring portion 261.

The supporting portion 262 supports the spring portion 261. In the example illustrated in FIGS. 8 and 9, the supporting portion 262 supports the plate portion 263 of the spring portion 261. Note that the supporting portion 262 may support the plate portion 264 or may support the bent portion 265. The supporting portion 262 is fixed to the holding portion 70. The supporting portion 262 protrudes from the holding portion 70. The supporting portion 262 includes a base portion 266 fixed to the holding portion 70, and a joining portion 267 that joins the base portion 266 and the spring portion 261. The base portion 266 is plate-shaped. A plate thickness (width) of the base portion 266 is smaller than the width of the press-fit groove 50 and at least half of the width of the press-fit groove 50. A width of the joining portion 267 is smaller than the width of the base portion 266 and less than half of the press-fit groove 50. Plate thicknesses of the plate portions 263 and 264 are smaller than the width of the base portion 266 and less than half of the press-fit groove 50.

In the press-fitting step, the conducting portion 260 is press-fitted into the press-fit groove 50 via the opening portion 51, by displacing the unit component 203 to the other axial side so that the bent portion 265 of the spring portion 261 goes into the press-fit groove 50. With this, the conducting portion 260 is press-fitted into the press-fit groove 50 and pressed against the protruding portion 29.

### Third Embodiment

In a third embodiment, a second other example of the conducting portion will be described. Note that in the description of the third embodiment, constituent elements identical to those in the first embodiment will be denoted by the same reference numerals and detailed description thereof will be omitted.

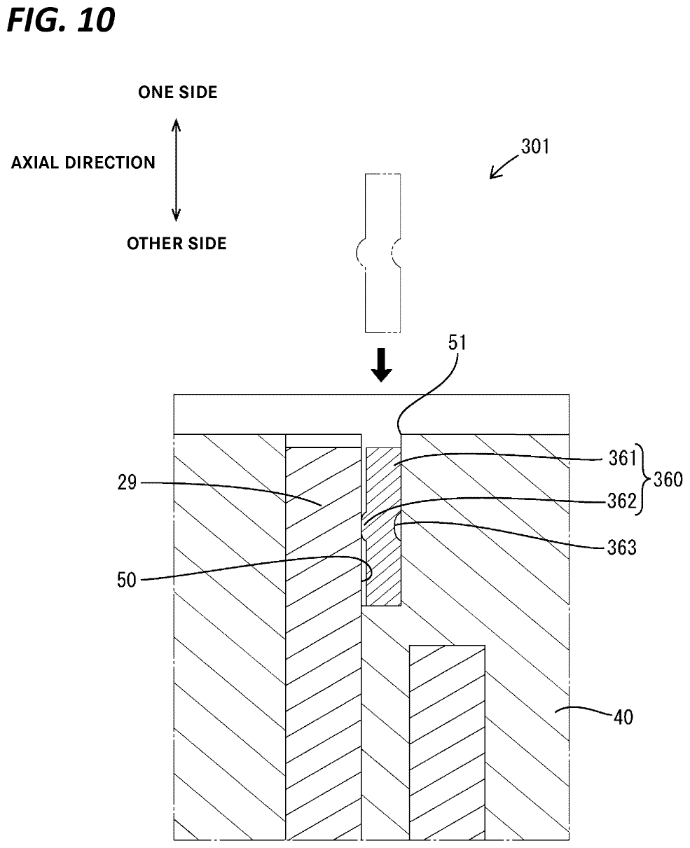

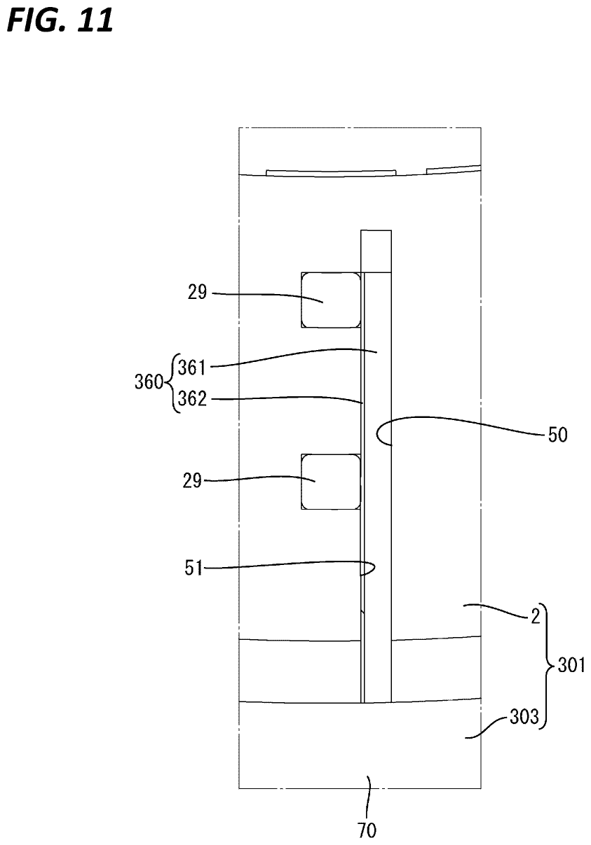

As illustrated in FIGS. 10 and 11, a stator 301 of the third embodiment includes the stator body 2 and a unit component 303. The unit component 303 includes a conducting portion 360, the holding portion 70, and the terminal portion 80 (see FIG. 1).

The conducting portion 360 is, for example, a busbar. The conducting portion 360 includes a conductor body 361 and a projecting portion 362 that projects from the conductor body 361.

The conductor body 361 is plate-shaped. A plate thickness direction of the conducting portion 60 is a direction along the circumferential direction. A plate thickness of the conductor body 361 is slightly smaller than the width (length in a direction orthogonal to the axial direction and the radial direction) of the press-fit groove 50. The conductor body 361 extends along the radial direction. The conductor body 361 is disposed in the press-fit groove 50.

The projecting portion 362 is a part that is crushed when the conducting portion 360 is press-fitted into the press-fit groove 50. The projecting portion 362, the conductor body 361 has a form in which the projecting portion 362 projects to the protruding portion 29 side. The projecting portion 362 extends along the radial direction. The projecting portion 362 is curved so as to be convex to the protruding portion 29 side.

A surface at a side opposite to a side at which the projecting portion 362 of the conductor body 361 is disposed includes a recessed surface 363. The recessed surface 363 is provided at a position corresponding to the projecting portion 362. The conducting portion 360 is formed by, for example, bending a metal plate. The projecting portion 362 and the recessed surface 363 are formed simultaneously through the bending.

The conducting portion 360 is disposed in a state in which the conducting portion 360 is press-fitted into the press-fit groove 50 and the projecting portion 362 is pressed against the protruding portion 29. The conducting portion 360 is disposed in the state in which the projecting portion 362 is pressed against two or more (two in the present embodiment) protruding portions 29 regularly arranged in the radial direction. According to this configuration, the stator 301 allows a connection to be made and a stress to be easily concentrated, since a connecting part of the conducting portion 360 with the protruding portion 29 is easily limited to the projecting portion 362.

In the press-fitting step, the conducting portion 360 is press-fitted into the press-fit groove 50 and the conducting portion 360 is pressed against the protruding portion 29. In the press-fitting step, the respective conducting portions 360 are press-fitted into the respective press-fit grooves 50 via the opening portion 51, by displacing the unit component 303 to the other axial side.

### Fourth Embodiment

In a fourth embodiment, a third other example of the conducting portion will be described. Note that in the description of the fourth embodiment, constituent elements identical to those in the first embodiment will be denoted by the same reference numerals and detailed description thereof will be omitted.

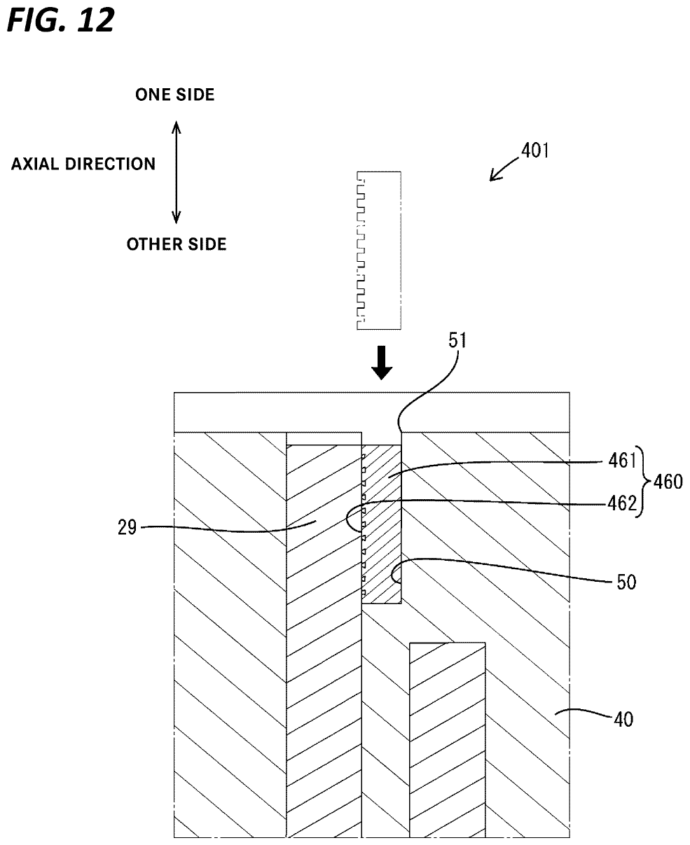

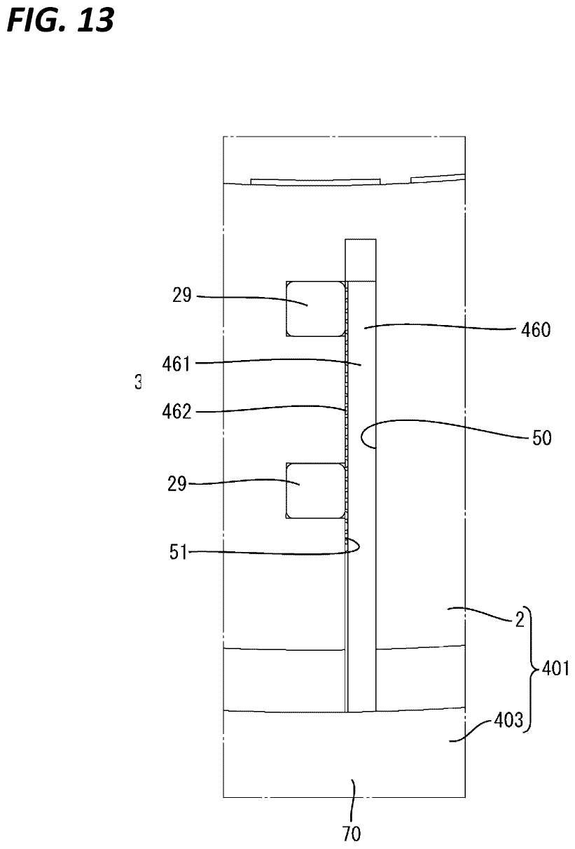

As illustrated in FIGS. 12 and 13, a stator 401 of the fourth embodiment includes the stator body 2 and a unit component 403. The unit component 403 includes a conducting portion 460, the holding portion 70, and the terminal portion 80 (see FIG. 1).

The conducting portion 460 is, for example, a busbar. The conducting portion 460 includes a conductor body 461. The conductor body 461 is disposed in the press-fit groove 50. A surface at a side at which the protruding portion 29 of the conductor body 461 is disposed includes an uneven surface 462. The uneven surface 462 is pushed against the protruding portion 29 and crushed when the conducting portion 460 is press-fitted into the press-fit groove 50. With this, the conducting portion 460 is disposed in a state in which the conducting portion 460 is press-fitted into the press-fit groove 50 and pressed against the protruding portion 29. This configuration allows a connection state between the conducting portion 460 and the protruding portion 29 to be easily stabilized over a wide range.

In the press-fitting step, the conducting portion 460 is press-fitted into the press-fit groove 50 and the conducting portion 460 is pressed against the protruding portion 29. In the press-fitting step, the respective conducting portions 460 are press-fitted into the respective press-fit grooves 50 via the opening portion 51, by displacing the unit component 403 to the other axial side. When the coil 20 (more specifically, the protruding portion 29) is a coated wire, an advantageous effect can be expected of the coating being peeled off by the uneven surface 462 and more reliably ensuring a connection state between the interior core wire and the conducting portion 460.

### Fifth Embodiment

In a fifth embodiment, another example relating to a positional relationship between the conducting portion and the protruding portion will be described. Note that in the description of the fifth embodiment, constituent elements identical to those in the first embodiment will be denoted by the same reference numerals and detailed description thereof will be omitted.

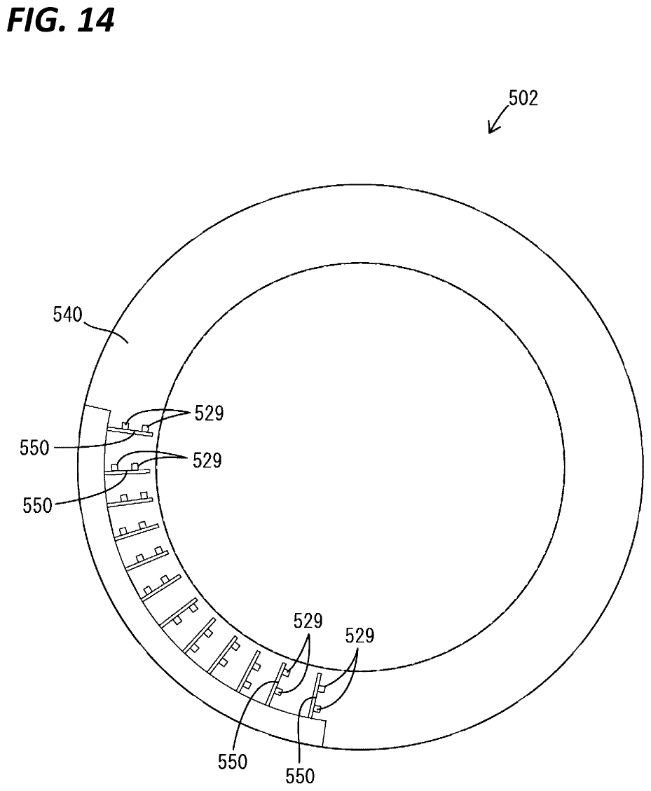

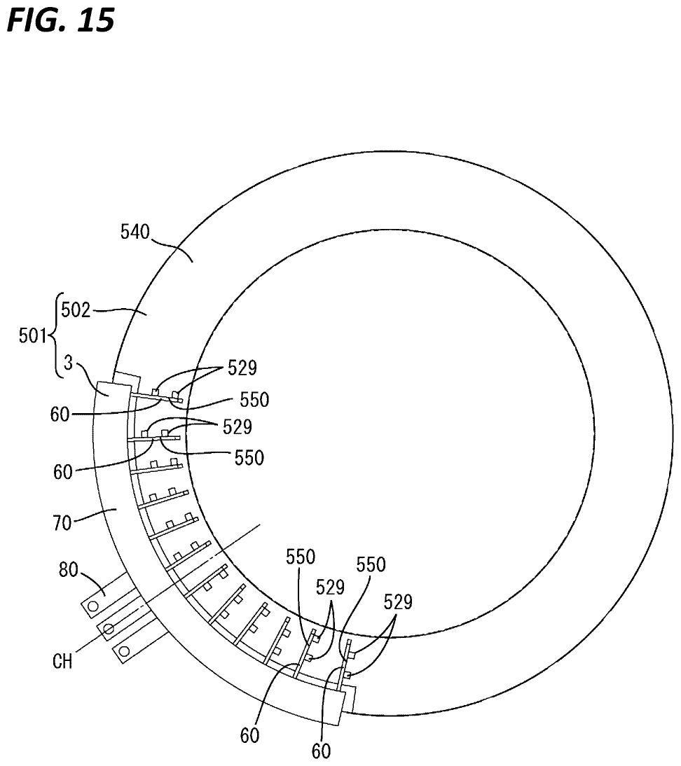

As illustrated in FIGS. 14 and 15, a stator 501 of the fifth embodiment includes a stator body 502 and the unit component 3. The unit component 3 includes the conducting portion 60, the holding portion 70, and the terminal portion 80.

The stator body 502 differs from the stator body 2 of the first embodiment in that a positional relationship between the press-fit groove and the protruding portion is different, but is otherwise the same. The stator body 502 includes a plurality of protruding portions 529. The plurality of protruding portions 529 are regularly arranged in the circumferential direction. The stator body 502 includes an insulating resin 540. The insulating resin 540 includes a plurality of press-fit grooves 550 regularly arranged in the circumferential direction, the plurality of press-fit grooves 550 being disposed between the insulating resin 540 and the plurality of protruding portions 529 regularly arranged in the circumferential direction. Each protruding portion 529 is disposed at a side opposite to a side at which a circumferential direction center CH of the holding portion 70 is positioned, with respect to the press-fit grooves 550 forming the protruding portions 529.

The respective conducting portions 60 are press-fitted into the respective press-fit grooves 550. Each conducting portion 60 is disposed at the side at which the circumferential direction center CH of the holding portion 70 is positioned, with respect to a corresponding one of the protruding portions 529 being a connection target. According to this configuration, the stator 501 allows a connection state between the conducting portions 60 and the protruding portions 529 to be easily maintained, since each conducting portion 60 is displaced to a side at which the corresponding one of the protruding portions 529 being the connection target is disposed, even when the holding portion 70 thermally expands and deforms so that a curvature thereof is reduced.

### OTHER EMBODIMENTS

The present disclosure is not limited to the embodiments described above with reference to the description and drawings. For example, the features of the embodiments described above and below can be combined in various ways provided that no contradiction arises. Also, any features of the embodiments described above or below can be omitted unless they are clearly described as being essential. Furthermore, the above-described embodiments may be changed in the following manner.

The first coil end need not include the first lead portion. In other words, the extending portion may be continuous with the insertion portion. The extending portion may extend from the end portion at the one axial side of the stator core to the one axial side.

The second coil end need not include the second lead portion. In other words, the protruding portion may be continuous with the insertion portion. The protruding portion may protrude from the end portion at the one axial side of the stator core to the one axial side.

In each of the above embodiments, the plurality of protruding portions connected to one conducting portion are disposed at the same side in the circumferential direction with respect to the conducting portion, but may be disposed at both sides in the circumferential direction of the conducting portion.

In each of the above embodiments, two or more protruding portions are regularly arranged in the radial direction, but the present disclosure is not limited to this configuration. For example, the protruding portions need not be regularly arranged in the radial direction.

In each of the above embodiments, the entirety in the axial direction of the conducting portion is fitted inside the press-fit groove, but only a part in the axial direction may be fitted inside the press-fit groove.

In each of the above embodiments, the conducting portion is press-fitted into the press-fit groove from the one axial side, but may also be press-fitted from the outer radial side.

Note that the embodiments disclosed herein are exemplary in all respects, and should be construed as not being restrictive. The scope of the present invention is indicated by the appended claims rather than the above description, and all changes that fall within the same essential spirit as the scope of the claims are intended to be included therein.

### LIST OF REFERENCE NUMERALS

1 Stator
2 Stator body
3 Unit component
10 Stator core
11 Yoke portion
12 Teeth portion
15 Slot
20 Coil
21 Insertion portion
22 One-side coil end
23 Other-side coil end
24 First coil end
25 Second coil end
26 First lead portion
27 Extending portion
28 Second lead portion
29 Protruding portion
40 Insulating resin
41 Filling portion
42 Forming portion
43 One-side resin
44 Other-side resin
45 Recessed portion
50 Press-fit groove
51 Opening portion
52 Outer circumferential opening portion
60 Conducting portion
70 Holding portion
80 Terminal portion
90 Drive unit
201 Stator
203 Unit component
260 Conducting portion
261 Spring portion
262 Supporting portion
263 Plate portion
264 Plate portion
265 Bent portion
266 Base portion
267 Joining portion
301 Stator
303 Unit component
360 Conducting portion
361 Conductor body
362 Projecting portion
363 Recessed surface
401 Stator
403 Unit component
460 Conducting portion
461 Conductor body
462 Uneven surface
501 Stator
502 Stator body
529 Protruding portion
540 Insulating resin
550 Press-fit groove
CH Circumferential direction center of holding portion

1. A stator comprising:
an annular stator core;
a coil including a protruding portion that protrudes to one axial side more than an end portion at the one axial side of the stator core;
a conducting portion connected to the protruding portion; and
an insulating resin including a press-fit groove between the insulating resin and the protruding portion, wherein
the conducting portion is disposed in a state in which the conducting portion is press-fitted into the press-fit groove and pressed against the protruding portion.

2. The stator according to claim 1, wherein
a plurality of the protruding portions are provided,
the plurality of protruding portions are regularly arranged in a circumferential direction of the stator core,
the insulating resin includes a plurality of the press-fit grooves regularly arranged in the circumferential direction, the plurality of press-fit grooves being disposed between the insulating resin and the plurality of protruding portions regularly arranged in the circumferential direction,
a plurality of the conducting portions are provided,
the stator further comprises a holding portion that holds the plurality of conducting portions, and
the conducting portions held by the holding portion are disposed in a state in which the respective conducting portions are press-fitted into the respective press-fit grooves and pressed against the respective protruding portions.

3. The stator according to claim 2, wherein
the plurality of press-fit grooves regularly arranged in the circumferential direction radially extend along a radial direction of the stator core,
each of the press-fit grooves includes an opening portion that opens toward the one axial side, and
each of the conducting portions is removable from each of the press-fit grooves through the opening portion.

4. The stator according to claim 2, wherein
each of the press-fit grooves includes an outer circumferential opening portion that opens radially outward of the stator core,
the holding portion is disposed at a more radially outward position than the plurality of press-fit grooves regularly arranged in the circumferential direction, and
the respective conducting portions held by the holding portion protrude from a surface at an inner radial side of the holding portion and are disposed in the respective press-fit grooves via the outer circumferential opening portions.

5. The stator according to claim 4, the stator is a stator used in a motor, the stator comprising:
a terminal portion electrically connected to a drive unit that drives the motor, wherein
the terminal portion has a form in which the terminal portion protrudes from a surface at an outer radial side of the holding portion.

6. The stator according to claim 3, wherein
each of the press-fit grooves includes an outer circumferential opening portion that opens radially outward of the stator core,
the holding portion is disposed at a more radially outward position than the plurality of press-fit grooves regularly arranged in the circumferential direction,
the respective conducting portions press-fitted into the respective press-fit grooves are coupled to a surface at an inner radial side of the holding portion via the outer circumferential opening portions, and
the opening portion and the outer circumferential opening portion open continuously.

7. The stator according to claim 2, wherein
the holding portion has a form in which the holding portion extends along the circumferential direction in a circular arc shape, and
each of the plurality of conducting portions is disposed at a side at which a circumferential direction center of the holding portion is located with respect to a corresponding one of the plurality of protruding portions being a connection target.

8. The stator according to claim 1, wherein
a plurality of the protruding portions are provided,
the plurality of protruding portions are regularly arranged in a circumferential direction of the stator core,
the insulating resin includes a plurality of the press-fit grooves regularly arranged in the circumferential direction, the plurality of press-fit grooves being disposed between the insulating resin and the plurality of protruding portions regularly arranged in the circumferential direction,
a plurality of the conducting portions are provided,
the conducting portions are disposed in a state in which the respective conducting portions are press-fitted into the respective press-fit grooves and pressed against the respective protruding portions,
an entirety in the axial direction of each conducting portion is fitted inside a corresponding press-fit groove, and
a side of the protruding portions opposite to a press-fit groove side is covered by the insulating resin.

9. The stator according to claim 1, wherein
the stator core includes a plurality of slots regularly arranged in a circumferential direction of the stator core,
the coil includes an insertion portion disposed in each slot,
the insulating resin includes a filling portion that is filled continuously between an inner wall of each slot and the insertion portion, and a forming portion in which the press-fit groove is formed, and
the filling portion and the forming portion are integrally formed.

10. The stator according to claim 1, wherein
the coil includes two or more protruding portions regularly arranged in a radial direction of the stator core,
one of the press-fit grooves is formed between the two or more protruding portions and the insulating resin, and
one of the conducting portions is disposed in a state in which the one conducting portion is press-fitted into the one press-fit groove and pressed against the two or more protruding portions forming the press-fit groove.

11. A method for manufacturing a stator, the method comprising:
a preparation step of preparing a stator body including an annular stator core, a coil including a protruding portion that protrudes to one axial side more than an end portion at the one axial side of the stator core, a conducting portion connected to the protruding portion, and an insulating resin including a press-fit groove between the insulating resin and the protruding portion; and
a press-fitting step of press-fitting the conducting portion into the press-fit groove of the stator body and pressing the conducting portion against the protruding portion.

12. The method for manufacturing the stator according to claim 11, wherein
the preparation step includes preparing a unit component having a configuration in which a plurality of the conducting portions are held by a holding portion,
a plurality of the protruding portions are provided,
the plurality of protruding portions are regularly arranged in a circumferential direction of the stator core,
the insulating resin includes a plurality of the press-fit grooves regularly arranged in the circumferential direction, the plurality of press-fit grooves being disposed between the insulating resin and the plurality of protruding portions regularly arranged in the circumferential direction,
each of the press-fit grooves includes an opening portion that opens toward the one axial side, and
the press-fitting step includes press-fitting the respective conducting portions into the respective press-fit grooves via the opening portions, by displacing the unit component to an other axial side.

13. The method for manufacturing the stator according to claim 11, wherein
the stator core includes a plurality of slots regularly arranged in a circumferential direction of the stator core,
the coil includes an insertion portion disposed in each slot,
the method further comprises a filling step of charging a resin material between an inner wall of each slot and the insertion portion, and
the filling step forms the press-fit groove while charging the resin material between the inner wall of the slot and the insertion portion.
